(19) United States
(12) Patent Application Publication
(10) Pub. No.: US 2009/0007827 A1
(43) Pub. Date: Jan. 8, 2009

(54) System and Method for Minimizing Nitrogen Oxide (NOx) Emissions in Cyclone Combustors

(76) Inventors: Hamid Sarv, Canton, OH (US); Gerald J. Maringo, Canton, OH (US); Alan Neal Sayre, North Canton, OH (US); Rajani Kanth Varagani, Bear, DE (US)

Correspondence Address: THE BABCOCK & WILCOX COMPANY, PATENT DEPARTMENT, 20 SOUTH VAN BUREN AVENUE, BARBERTON, OH, 44203, US

(21) Appl. No.: 12/129,052

(22) Filed: May 29, 2008

Related U.S. Application Data
(60) Provisional application No. 60/942,028, filed on Jun. 5, 2007.

(51) Int. Cl. B01D 53/56; F23C 6/04; F23L 9/02; F23C 5/32; F23J 15/00

(52) U.S. Cl. 110/345; 431/9; 431/10; 110/210; 110/214

(57) ABSTRACT

A combustion system equipped with one or more carbonaceous fuel burning combustors (e.g., slagging Cyclone combustor) and adapted to minimize nitrogen oxide (NOₓ) formation during staged combustion operation by selective introduction of oxygen through at least one of the combustors to create a hot sub-stoichiometric combustion zone by reducing the diluent effect of nitrogen and other inert gases present in the oxidizer/air. A method of operating the combustion system of the invention with reduced NOₓ emissions is also disclosed.

This Invention was made with Government support under Contract No. DE-FC26-05NT42301 awarded by the Department of Energy. The Government may retain certain rights in this invention.

### FIELD AND BACKGROUND OF THE INVENTION

The present invention relates generally to a combustion system equipped with, e.g., a slagging Cyclone™ combustor, which is adapted to minimize nitrogen oxide (NOₓ) formation during staged combustion operation by selective use of oxygen, and a method of operating the combustion system of the invention with decreased NOₓ emissions.

Cyclone boilers are among the most efficient commercially-operated coal combustion systems, currently representing about 8% of the coal-fired boiler capacity in the United States. As the name implies, the Cyclone combustor operates typically at high speeds (˜200+mph) with cyclonic flow characteristics. FIG. 1 shows the basic arrangement of a Cyclone furnace boiler. Crushed coal (smaller than No. 4 US Sieve) from a feeder and primary air (PA) are swirled in a burner 15 at the front center of the Cyclone. In some applications, tertiary air (TA) is introduced to the center of the burner 15 to control the position of the flame in the Cyclone. As the coal/air mixture enters the Cyclone barrel, it encounters a high-speed vortex from the heated (>500° F.) secondary air 5. Fine coal particles burn in suspension and exit the center re-entrant throat cone 18 with hot gases. Due to the centrifugal action, large particles are thrown toward the inner walls of the Cyclone barrel where they are captured and burned in a molten slag layer. The molten mineral matter (ash) exits the Cyclone slag tap 16 below the Cyclone re-entrant throat cone 18, flows into the primary boiler furnace, and drops from the furnace slag tap 19 into a water-filled tank 20 via a short vertical chute as shown in FIG. 1. About 70-85% of the coal ash leaves the Cyclone as slag. Cyclone furnaces and boilers generate high NOₓ emissions due to the intense fuel/air mixing. Uncontrolled NOₓ emissions from commercial Cyclone-fired power plants are typically in the 1.0-1.7 lb NOₓ/million Btu range.

Coals for Cyclone firing must be selected carefully to ensure that the molten ash can flow and tap steadily out of the furnace. The use of Cyclone fuels with slag viscosity factors or T₂₅₀ values of 2450° F. (1616° K) and 2300° F. (1533° K) for burning bituminous and sub-bituminous coals, respectively is recommended. T₂₅₀ denotes the temperature at which the slag can flow at a viscosity of 250 poise. Occasionally, the slag may solidify in the Cyclone or furnace and require special operating practices or mechanical intervention to achieve acceptable slagging conditions. Refractory lining of the Cyclone is necessary to maintain high combustion temperatures and proper heat transfer performance.

### Air Staging

Burning of fossil fuels in air generates NOₓ (NO+NO₂) from the oxidation of fuel-nitrogen content and/or oxidation of atmospheric nitrogen in the combustion air. Air staging is a commercially practiced method for NOₓ reduction wherein the main combustion zone is operated fuel-rich (sub-stoichiometric) by diverting a part of the total combustion air and reintroducing it downstream through overfire air (OFA) ports. Typical cyclone combustion stoichiometries range from 0.9 to 1.0 and with the addition of OFA, the overall stoichiometry is raised to a range of 1.10 to 1.25. Air-staged combustion in Cyclone-fired units generates typically 40-70% less NOₓ relative to unstaged combustion.

Combustion stoichiometry or stoichiometric ratio (SR) is defined as the actual oxidizer-to-fuel mass ratio divided by the stoichiometric (theoretical) oxidizer-to-fuel mass ratio as expressed below:

$$S R ≡ \frac{{( oxidizer / fuel )}_{actual}}{{( oxidizer / fuel )}_{stoichiometric}}$$

For a known fuel, the stoichiometric oxidizer-to-fuel mass ratio can be calculated directly from the chemical composition of the oxidizer and the fuel. The actual oxidizer-to-fuel mass ratio is calculated from a desired operating condition. Based on this definition, the stoichiometric, fuel-lean, and fuel-rich operations correspond to SR=1.0, SR>1.0, and SR<1.0, respectively. Stoichiometric operation corresponds to a theoretical condition where there is just sufficient oxidant to completely oxidize the fuel. In practical combustors, fuel/oxidant mixing imperfections result in requiring excess oxidant levels to burnout the combustibles. The excess oxidant is either added directly into the combustion zone or injected through furnace openings downstream of it.

### Flue Gas Recirculation

Flue gas recirculation (FGR) into a fuel-rich, sub-stoichiometric combustion zone can destroy the NOₓ content of the recycled stream and convert it to N₂, thereby reducing the net NOₓ emissions at the stack. However, the FGR flow into the Cyclone furnace can also quench the combustion reactions and reduce the temperature below the recommended values for melting the coal ash.

### Fuel Reburning

Fuel reburning is another proven commercial technology in which a supplementary fuel (e.g., natural gas, fuel oil, or pulverized coal) and air are added at an elevation above the generally fuel-lean (stoichiometric ratio, SR≧1.0) main flame zone to create a locally oxygen-deficient, reburn zone (SR<1.0). In the reburn zone, the supplementary fuel generates hydrocarbon radicals, amines, and cyanic species that react with the incoming main combustion zone elevation products to convert NOₓ to N₂. Additional air is introduced through the OFA ports above the reburn zone to burn out the combustible matter at overall stoichiometries of 1.10 to 1.25. Up to 70% NOₓ reduction with 30% fuel reburn has been demonstrated in coal-fired boilers.

Unfortunately, neither the air staging process nor the fuel reburning method alone can reduce the NOₓ emissions in coal-fired units sufficiently to environmentally compliant levels. Although post-combustion flue gas treatment (i.e., SCR and SNCR) processes could be installed to achieve the desired emissions target, the NOₓ removal cost would increase substantially.

Thus, there exists a need for a system and process which do not have the above-mentioned shortcomings and can achieve maximum in-furnace NOₓ reduction via a more cost-effective approach involving partial use of oxygen in the Cyclone combustor and/or fuel reburning.

### SUMMARY OF THE INVENTION

The present invention discloses a system and method for minimizing nitrogen oxide (NOₓ) emissions resulting from the combustion of a carbonaceous fuel.

For the purposes of the present invention, the term air shall have its common meaning, a gas comprising about 21 percent oxygen and about 78 percent nitrogen. Accordingly, as would be appreciated by the skilled artisan, the terms oxygen and air are not synonymous in name, composition, or purpose with regard to the method and system of the present invention. In regard to gaseous streams, the term oxygen stream as used in the claims shall mean a gaseous stream comprising at least 85 percent oxygen and preferably at least 90 percent oxygen.

A preferred system of the present invention comprises a boiler having a combustion zone; a slagging Cyclone combustor arranged at a lower region of the combustion zone; an injector for supplying a carbonaceous fuel and an oxygen stream into the combustor, the oxygen stream providing about 2-15% of the total oxygen flowing into the boiler via all recycled flue gas, air, and oxygen streams, wherein the fuel and the oxidant are utilized by the combustor at a combustion stoichiometry of less than 1.0 to generate a combustion product; and overfire air ports for supplying overfire air into an upper region of the combustion zone to contact the overfire air with the combustion product produced by the combustor at about the upper region of the combustion zone and increase overall stoichiometry above 1.0, thereby substantially completing the combustion process and reducing oxidation of nitrogen-carrying species in the combustion product to nitrogen oxide.

A preferred method of the present invention comprises the steps of providing a boiler having a combustion zone; providing a combustor at a lower region of the combustion zone; introducing a carbonaceous fuel and an oxygen stream into the combustor, the oxygen stream providing about 2-15% of the total oxygen flowing into the boiler via all recycled flue gas, air, and oxygen streams; introducing overfire air into an upper region of the combustion zone; combusting the fuel and the oxidant at a combustion stoichiometry of less than 1.0 to generate a combustion product; and contacting overfire air with the combustion product about the upper region of the combustion zone to increase overall stoichiometry above 1.0, thereby substantially completing the combustion process and reducing oxidation of nitrogen-carrying species in the combustion product to nitrogen oxide.

As an option, oxygen may be supplied through the secondary air entrance of the Cyclone combustor, preferably with a multi-hole oxygen lance, and the overfire air may be supplied through a plurality of overfire air ports disposed on at least one elevation. Preferably, the overfire air is distributed equally among the plurality of overfire air ports, but in alternative embodiment the overfire air can also be distributed unequally amongst the plurality of overfire air ports.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 shows a Cyclone furnace boiler with slag removal system;

FIG. 2 shows a Cyclone furnace configuration of the present invention;

FIG. 3a shows a frontal view of a oxygen enrichment of a Cyclone furnace for staged sub-stoichiometric operation;

FIG. 3b shows a frontal view of a oxygen enrichment of a Cyclone furnace for staged sub-stoichiometric operation

FIGS. 4 A, B, and C shows deeply-staged, oxygen-enriched, Cyclone furnace configurations of the present invention without reburn (A) and with reburn (B-C); and

FIG. 5 shows computed Cyclone mid-plane contour plots of temperature (° K) and O₂ mole fractions for staged combustion of Pittsburgh #8 coal in the Cyclone furnace at 0.80 stoichiometry (left plots (A): 100% firing rate without O₂-enrichment; middle plots (B): 70% firing rate without O₂-enrichment; and right plots (C): 70% firing rate plus 10% O₂-enrichment).

FIG. 6 is a graphical representation of Cyclone stoichiometry effect on the coal flame temperature rise due to enrichment of air with oxygen at 5% (circles) and 10% (triangles) levels, wherein percent volumetric concentrations of O₂ in the combined secondary air and oxygen streams are printed next to each point on the plots

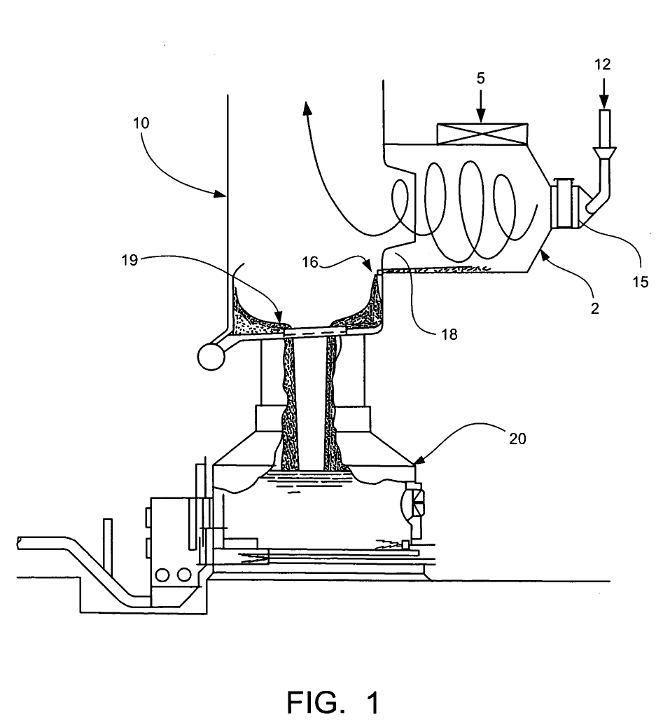

### DESCRIPTION OF THE PREFERRED EMBODIMENTS

The present invention relates, among other aspects, to a method of minimizing NOₓ emissions in boiler units equipped with coal-burning Cyclone combustors by selective use of oxygen during staged combustion operation. In an embodiment, a portion of the oxidizer/air flow to the Cyclone combustor is replaced with oxygen to create a hot sub-stoichiometric combustion zone via reducing the diluent effect of nitrogen and other inert gases present in oxidizer/air. Preferably, oxygen enrichment of the Cyclone is equivalent to 2-15% of the total oxygen flow via the air, recycled flue gas and oxygen stream to the boiler. This allows the Cyclone to operate at lower stoichiometries while maintaining the required high combustion temperatures for proper slag tapping. High-temperature combustion at low stoichiometries accelerates the fuel pyrolysis, enhances the production of NOₓ reduction precursors, and improves the char burnout.

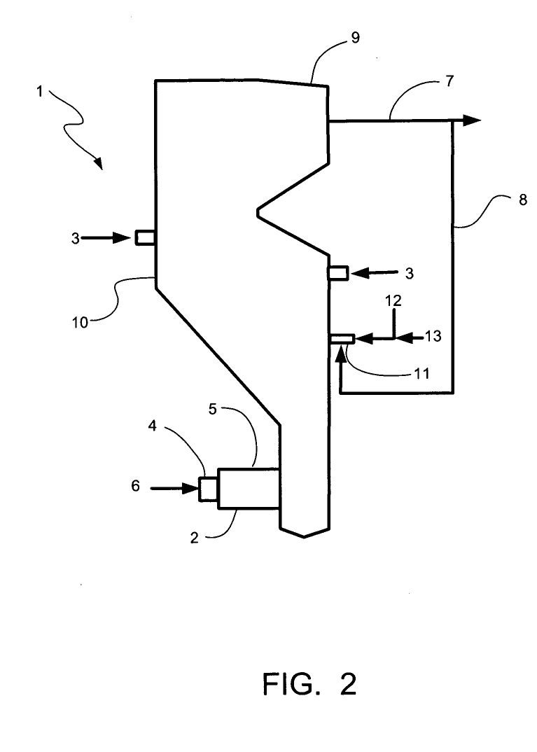

Referring to the drawings, FIG. 2 shows a system 1 of the present invention comprising a Cyclone furnace generally designated 10 having a Cyclone combustor 2 with a generally cylindrical Cyclone barrel. The Cyclone barrel includes a primary 4, secondary 5 and tertiary 6 air conduit. Oxygen is preferably supplied with the secondary air stream 5.

In a preferred method of injecting oxygen, the oxygen is injected via a multi hole secant lance injector. The lance is preferably placed in the secondary air conduit of the Cyclone combustor, the holes of the injector being positioned in a manner allowing co-current flow of the injected oxygen with any gaseous stream flowing within the secondary air conduit and into the Cyclone barrel. The lance can be of any design, preferably a cylindrical construction is used, wherein the length of the injector extends across the entire or a substantial portion of the secondary air conduits width. The lance generally is design to pass through one wall of the secondary air conduit at a median elevation, and fitted to the opposite wall to maintain injector elevation across the width of the secondary air conduit. Alternatively in embodiments utilizing rigid injector structures, opposite wall fittings may not be necessary.

An injector according to the present invention generally comprises a plurality of openings along the injector length. The openings may vary in shape and size such that a large shape may only require a single opening to permit optimal oxygen stream flow whereas a smaller shape may require multiple openings to permit optimal oxygen stream flow. Preferably the openings are of a circular shape, equally spaced along the injector length. Alternatively the opening(s) can be spaced non-equally or irregularly along the injector length, and may be of any non-circular shapes, such as but not limited to elliptical, rectangular, triangular shapes, and any combination thereof for example.

An injector according to the present invention is preferably located sufficiently within the secondary air conduit, allowing the oxygen stream injected though the lance to be adequately mixed with the gaseous mass flowing through the secondary air conduit prior to the combined stream being introduced in the Cyclone barrel. Adequate mixing provides the benefit of a uniform temperature distribution within the Cyclone barrel, enhancing the Cyclones ability to function and melt ash at a combustion stoichiometry below 1.0 and as low as about 0.5.

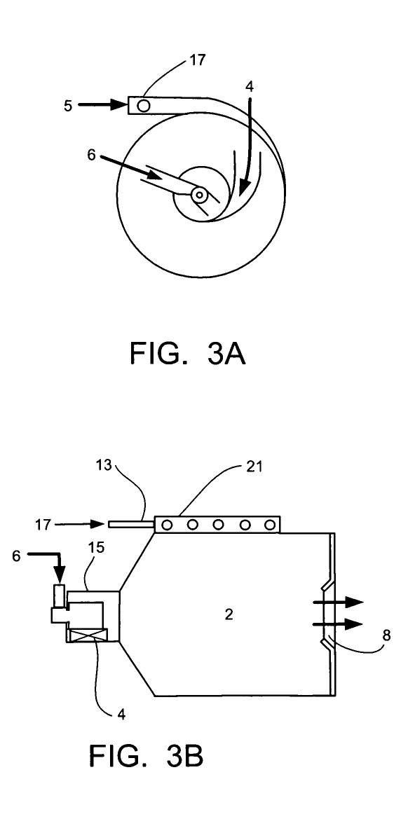

FIGS. 3A and B show oxygen-enrichment of the Cyclone furnace by a multi-hole (shown as 5 holes) O₂ lance 13 positioned near the entrance of secondary air 5 into the Cyclone furnace 2. Referring again to FIG. 2, to further reduce NOₓ, staging or overfire air is introduced through overfire air (OFA) ports 3 disposed on at least one elevation to raise the overall stoichiometry above 1.0. Multi-level addition of staging air is more effective for NOₓ minimization than single-level because the gradual addition of OFA above the main combustion zone reduces the oxidation of nitrogen-carrying species in the flue gas stream (e.g., HCN, NH₃, and char-nitrogen) to NOₓ. While it is preferable to split the total staging air equally among the different level OFA ports, optimum performance may require non equal OFA distribution.

More NOₓ reduction can be achieved by extracting a small amount of flue gas 7 from the convection pass section and downstream of the furnace exit 9 of the boiler and recirculating it into the boiler through wall penetrations between the Cyclone combustion zone and the OFA ports. Alternatively, the flue gas recirculation (FGR) 8 can flow through a set of small burners 11 (for the optional firing of a mixture 12 of fuel and oxidizer) equipped with swirl blades to achieve desired flow and mixing patterns. In any case, the FGR flow is expected to be less than 25% of the total flue gas exiting the boiler. Typical Cyclone furnace stoichiometry will range from 0.5 to 1.0. In the event of firing coal through reburn burners, the reburn burner stoichiometric ratio is determined from the coal feed rate, transport air flow rate, and the flow rate and composition of the recycled flue gas. In one embodiment, the reburn burners may include an oxygen injector, such as a centerline oxygen lance 13. With or without reburning, the combined stoichiometry of all fuel and gaseous streams entering the boiler prior to the introduction of OFA should be about 0.5 to about 1.0 for maximum NOₓ reduction. With the addition of overfire air flow, the overall combustion stoichiometry is raised to 1.10 or higher to burn out the combustibles such as chars, hydrocarbons, and CO.

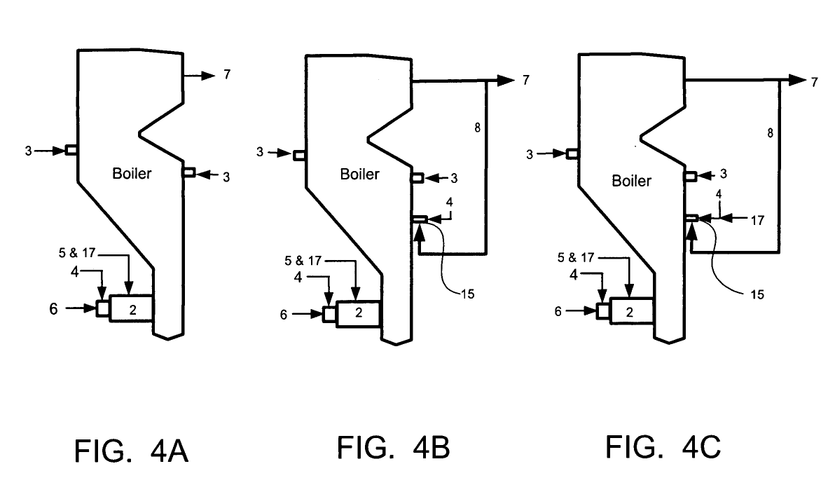

Possible applications include Cyclone furnaces and other slagging combustors arranged as single wall, opposed wall, one-level, or multi-level. FIG. 4 shows three oxygen-enriched Cyclone furnace configurations. FIG. 4(A) shows the boiler arranged with two levels of OFA ports. FIG. 4(B) depicts added reburn burners with FGR flow. FIG. 4(C) includes a centerline oxygen lance in the reburn burner. Actual number and size of Cyclone furnaces, reburn burners, OFA ports, and the spacing between them can vary depending on the size of the power plant, fuel type, boiler design, and other operating factors. Fuel oil, natural gas, agriculturally-derived fuels, petroleum coke, or others can be supplied as alternative fuels using appropriate fuel handling/delivery systems.

The present invention offers the following demonstrated advantages:

Extension of the lower combustion stoichiometry operability limit for Cyclone combustors down to 0.6 or lower;

Minimum oxygen requirement at deeply staged Cyclone furnace operating conditions;

NOₓ emissions below levels achieved with conventional staged combustion or reburning operation;

Higher turndown (ability to operate with good slag tapping at very low firing rates); and

Improved slag tapping, while minimizing mechanical intervention and changes in operation for removing solidified slag from the furnace.

The invention will be further illustrated by the following examples, but should not be considered as limited by those examples. Computer modeling and pilot-scale testing performed demonstrated the above-mentioned benefits.

### Example I

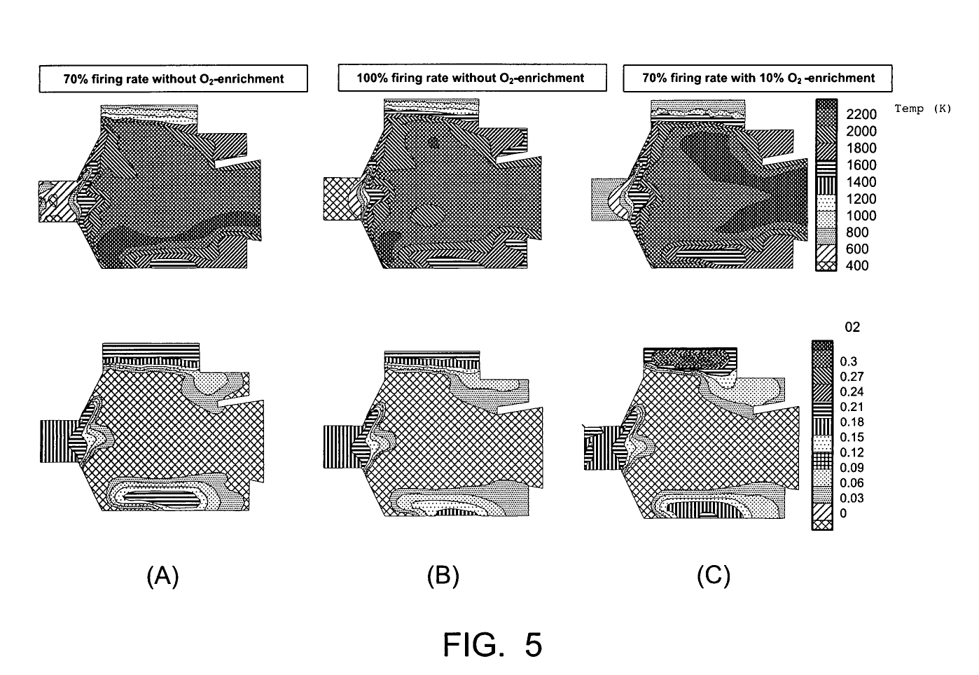

Computer simulations of coal combustion in an air-staged Cyclone furnace were performed under part load operation (70% firing rate) with and without oxygen injection, and at the baseline full load (100% firing rate) air-blown operation without oxygen addition. Two methods for oxygen injection into the cyclone combustor were simulated by computer modeling. One method involved a single-hole centerline lance and the other was a multi-hole secant injector at the secondary air entrance to the cyclone barrel. Oxygen injection at the secondary air entrance to the Cyclone barrel demonstrated a greater potential for adequate slag tapping than another arrangement involving a single-hole O₂ lance positioned along the Cyclone burner centerline. FIG. 5 compares the predictions of the multi-hole O₂ injection case with the no-oxygen enrichment results at part load and full load operations. Without oxygen enrichment, the Cyclone furnace at 70% firing rate (upper middle plot) was cooler in comparison with 100% firing operation (upper left plot). Oxygen enrichment in the Cyclone furnace at the 70% firing rate with the multi-hole lance had a similar temperature profile (upper right plot) to 100% firing rate without oxygen enrichment (upper left plot). Predicted O₂ profiles in the bottom plots of FIG. 5 indicate that the oxygen which enters the Cyclone furnace via the different air streams or the multi-hole lance is consumed rapidly under the sub-stoichiometric coal combustion conditions.

### Example II

Using the NASA Computer Program for Calculation of Complex Chemical Equilibrium Compositions and Applications (by McBride, B. J., and Gordon, S., NASA Reference Publication 1311, June 1996), the adiabatic flame temperature was computed over a 0.6 to 1.0 range of stoichiometric ratios for the premixed combustion of a high-volatile eastern bituminous coal with air as well as oxygen-enriched air. Pure oxygen was assumed to flow into a cyclone combustor at levels equivalent to 5% and 10% of the total oxygen entering the boiler (including the pure oxygen and various air streams) to burn the fuel and to generate a flue gas with 3.2% residual O₂ on a dry basis at the boiler exit. Since the coal feed rate and the oxygen flow rate into the cyclone combustor were held constant at a fixed oxygen enrichment level, the cyclone stoichiometric ratio was changed by varying the air flow to the cyclone and the overfire air ports.

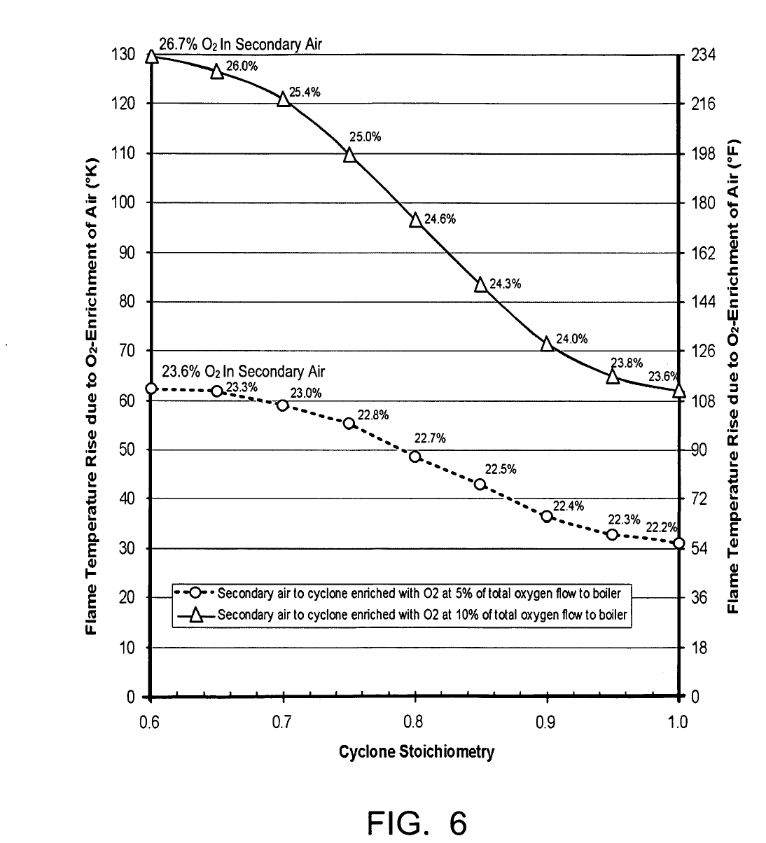

FIG. 6 shows the variations of the flame temperature rise due to oxygen enrichment of air in the cyclone combustor. Both curves show the general trend of increasing temperature difference as the combustion stoichiometry is reduced from the stoichiometric condition of 1.0 to the fuel-rich condition of 0.6. But the largest difference of 130° Kelvin (2340 Fahrenheit) occurred at the fuel-rich stoichiometry of 0.6 and with 10% oxygen enrichment, where the least amount of air entered the cyclone. In this embodiment, the pure form of oxygen is added only to the secondary air stream, the oxygen concentration of the combined secondary air and oxygen streams at selected stoichiometric ratios was calculated and indicated on the plots. At the 10% oxygen-enrichment level, the combined oxygen and secondary air streams produced O₂ concentrations of 23.6% to 26.7% by volume in the 1.0 to 0.6 cyclone stoichiometry range. For the 5% oxygen-enrichment cases over the same stoichiometry range, the oxidant O₂ concentrations varied from 22.2% to 23.6% by volume. Without oxygen-enrichment, the concentration of oxygen in the secondary air stream was 21% by volume which is typical for the atmospheric air.

### Example III

Proof-of-concept tests were performed at 5 million Btu/hr in a pilot-scale facility equipped with a Cyclone combustor. Oxygen lances were installed separately in the Cyclone and reburn burners for evaluation. Pure oxygen gas flow to the Cyclone combustor was varied from 0 to 10% of the total equivalent oxygen that entered the boiler via the air, recycled gas stream, and oxygen. In one series of tests, a high-volatile eastern bituminous Pittsburgh #8 seam coal was fired in both the Cyclone furnace and reburn burners. Best performance results of 112 ppmv NOₓ (0.146 lb/million Btu), 59 ppmv CO, and good slag tapping from the bottom of the primary furnace were achieved at 0.7 Cyclone stoichiometry with two levels of OFA ports and 1.17 overall stoichiometry, 10% coal reburning with air and 21% FGR, and 7% oxygen enrichment in the Cyclone furnace via a 5-hole oxygen lance as shown in FIG. 3. Without coal reburning or FGR and in the absence of oxygen flow to the Cyclone furnace operating at 0.7 stoichiometry, 158 ppmv NOₓ (0.226 lb/million Btu) and 48 ppmv CO were generated with two levels of OFA ports. With only the lower level OFA ports in service, 222 ppmv NOₓ (0.311 lb/million Btu), and 45 ppmv CO were generated. Un-staged NOₓ and CO emissions levels at 1.17 combustion stoichiometry were 870 ppmv (1.23 lb/million Btu) and 46 ppmv, respectively. Minimum combustion stoichiometry for maintaining good slag tapping was extended to 0.6 with 2.4% oxygen enrichment.

In a different series of tests, a sub-bituminous Powder River Basin Black Thunder coal was fired in the Cyclone furnace with two levels of OFA ports but without coal reburning or FGR. At 1.18 overall combustion stoichiometry, the average NOₓ concentration was 95 ppmv (0.126 lb/million Btu), and the average CO was 17 ppmv when the Cyclone furnace was staged close to 0.7 stoichiometry and the pure oxygen gas flow to the Cyclone furnace via the multi-hole lance was equivalent to 5% of the total oxidizer flowing into the furnace. Without the pure oxygen gas flow to the Cyclone furnace, the lowest stoichiometry for continuous slag tapping was 0.7. Under this condition and 1.17 overall stoichiometry, the NOₓ concentration was 108 ppmv (0.148 lb/million Btu), and the CO level was 24 ppmv. Un-staged NOₓ and CO emissions levels were 759 ppmv (1.04 lb/million Btu) and 27 ppmv, respectively. Oxygen enrichment at the 5% equivalent level extended the lower stoichiometry limit of the Cyclone furnace to 0.6 while maintaining good slag tapping. At 0.6 Cyclone furnace stoichiometry, 5% oxygen enrichment and 1.11 overall boiler stoichiometry, the NOₓ and CO emission levels were 96 ppmv (0.120 lb/million Btu) and 66 ppmv, respectively.

U.S. Pat. No. 6,910,432 B2 discusses embodiments where oxygen is introduced at various points either within or adjacent to the secondary air stream for selective oxygen enrichment in localized regions of the cyclone barrel. Unlike the prior art, in the present invention a uniquely designed multi discharge-hole oxygen lance was used to promote uniform dispersion and mixing of oxygen with the secondary air stream, and to elevate the flame temperature in the vicinity of the interior cyclone walls while achieving good slag tapping and low NOₓ emissions under sub-stoichiometric conditions. Other oxygen injection lances with non-uniform dispersion and mixing patterns that created locally oxygen-rich zones were also tested, but proved substantially less effective in minimizing NOₓ emissions.

We claim:

1. A method of minimizing nitrogen oxide emissions comprising the steps of:
providing a boiler having a combustion zone;
providing a combustor at a lower region of the combustion zone;
introducing a carbonaceous fuel, a air stream, and a oxygen stream into the combustor, wherein the oxygen stream provides about 2 percent to about 15 percent of the total oxygen flowing into the boiler;
producing a combustion product by combusting the carbonaceous fuel in the combustor at a stoichiometry of less than about 1.0,
reducing oxidation of nitrogen-carrying species in the combustion products to nitrogen oxide;
providing a over fire air port and introducing a over fire air stream into an upper region of the combustion zone through the over fire air port;
contacting the overfire air stream with the combustion product in the upper region of the combustion zone, and substantially completing the combustion process at a stoichiometry above about 1.0 and producing a flue gas.

2. The method of claim 1, wherein the combustor is a slagging Cyclone combustor.

3. The method of claim 2, comprising introducing the oxygen stream through a secondary air entrance of the combustor.

4. The method of claim 3, comprising introducing the oxygen stream to the combustor with a multi-hole, secant oxygen injector.

5. The method of claim 4, wherein the oxygen injector extends across a substantial portion of the secondary air entrance width.

6. The method of claim 1, wherein the over fire air stream is supplied through a plurality of over fire air ports disposed on at least one elevation.

7. The method of claim 6, wherein the over fire air stream is distributed equally among the plurality of over fire air ports.

8. The method of claim 7, wherein the over fire air stream is distributed unequally among the plurality of over fire air ports.

9. The method of claim 1, further comprising directing a portion of the flue gas from a convection pass section of the boiler through a plurality of boiler wall penetrations disposed between the combustor and the plurality of over fire ports.

10. The method of claim 9, wherein less than about 25 percent of the flue gas exiting the boiler is recirculated and directed to the wall penetrations.

11. The method of claim 1, further comprising providing a burner between the combustor and the over fire air port, combusting a supplementary carbonaceous fuel and a supplementary oxidant gas, generating a hydrocarbon radical species, and reacting the hydrocarbon radical species with nitrogen oxide in the combustion product to form nitrogen.

12. The method of claim 11, wherein the supplementary oxidant gas is comprised of the flue gas directed from a convection pass section of the boiler.

13. The method of claim 11, wherein the supplementary oxidant gas is a second oxygen stream comprising about 0 percent to about 5 percent of the total oxygen flowing into the boiler and is combusted with the supplementary fuel at a reburn stoichiometry of about 1.0 or less.

14. The method of claim 1, wherein the overall stoichiometry is between about 1.10 and about 1.25.

15. The method of claim 1, wherein the combustor stoichiometry is between about 0.5 and about 1.0.

16. The method of claim 1, combustor stoichiometry is below about 0.6.

17. A system for minimizing nitrogen oxide emissions comprising:
a boiler having a combustion zone;
a slagging Cyclone combustor in a lower region of the combustion zone;
an injector for supplying a carbonaceous fuel and an oxygen stream into the combustor, wherein the oxygen stream provides about 2 percent to about 15 percent of the total oxygen flowing into the boiler
a combustion product generated by combusting the carbonaceous fuel in the combustor at a combustion stoichiometry of less than about 1.0,
a secondary air entrance on the combustor, comprising a multi-hole, secant oxygen injector extending across a substantial portion of the secondary air entrance, and
a plurality of over fire air ports for supplying over fire air into an upper region of the combustion zone, wherein the addition of over fire air increases the overall stoichiometry in the upper region of the combustion zone above 1.0, producing a flue gas and substantially completing the combustion process and reducing oxidation of nitrogen-carrying species in the combustion product to nitrogen oxide.

18. The system of claim 17, wherein overfire air is not distributed equally among the plurality of over fire ports.

19. The system of claim 17, further comprising a bypass circuit to direct a portion of the flue gas from a convection pass section of the boiler through a plurality of wall penetrations disposed between the combustor and the over fire air ports, wherein less than about 25 percent of total flue gas exiting the boiler is recirculated and directed to the wall penetrations.

20. The system of claim 17, further comprising a set of burners arranged between the combustor and the over fire air ports for combusting a supplementary carbonaceous fuel and a supplementary oxidant gas, generating a hydrocarbon radical species, and reacting the hydrocarbon radical species with nitrogen oxide in the combustion product to form nitrogen.

21. The system of claim 17, wherein the stoichiometry upstream of the over fire air ports is between about 0.5 and about 1.0, and the stoichiometry downstream of the over fire air ports is between about 1.10 and about 1.25.

22. The system of claim 17, wherein the stoichiometry upstream of the over fire air ports is about 0.6.
